(19) United States
(12) Patent Application Publication
(10) Pub. No.: US 2009/0125994 A1
(43) Pub. Date: May 14, 2009

(54) Communication between a human user and a computer resistant to automated eavesdropping

(75) Inventor: Igor Fischer, Cologne (DE)

Correspondence Address: Igor Fischer, Metzer Str. 16, Cologne, 50677, omitted

(73) Assignee: Igor Fischer, Cologne (DE)

(21) Appl. No.: 11/939,561

(22) Filed: Nov. 14, 2007

(51) Int. Cl. H04L 9/32

(52) U.S. Cl. 726/6

(57) ABSTRACT

Communication between a human user and a computer over an insecure channel is accomplished by encoding user input using one or more character substitution tables. The character substitution tables are transmitted to the user over the insecure channel in a perceptually modified form which renders them difficult for use by automated adversaries but keeps them easily understandable by humans.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Sending a message over an open, insecure channel bears the risk of the message being eavesdropped on. Encryption is the process of scrambling the message (plaintext) in a predetermined manner, thus rendering it unintelligible to the eavesdropper. The inverse process of producing the original message back from its scrambled form (cyphertext) is called decryption. The manner in which the message is scrambled generally depends on two components, one being the cryptographic algorithm and the other the encryption key. Ideally, the message is scrambled in such way that only the intended recipient can decrypt it. Encryption, decryption, key generation and related tasks are commonly referred to as cryptography.

Modern cryptographic algorithms like DES or AES provide for high security using relatively short keys irrespective of message length. However, they involve complex computations which makes them highly impractical for a direct use by humans. They are almost exclusively applied for securing the communication between electronic devices, like computers, smart cards, mobile phones, and similar. If a human user wishes to send an encrypted message over an insecure channel, he or she needs first to enter the plaintext into a cryptographic module, which produces the cyphertext, before relaying it to the recipient.

If the cryptographic module is not available, e.g. when the user communicates over an ordinary telephone or over a dumb terminal, secure communication using modern cryptographic algorithms is almost impossible to perform. A similar problem arises if the cryptographic module is not a specialized device, but a program running inside an ordinary, general-purpose computer. In this case, an adversary can install a malicious program, for example a key logger, inside the computer without the user's knowledge. Then, user's messages can be intercepted by the malicious program before reaching the cryptographic program.

A simple and well-known alternative to modern cryptographic algorithms is the substitution cipher. As the name suggests, the message is encrypted by substituting each letter in it with another letter according to a substitution table. For a more detailed description, a reference is made to pages 7-8 of the book “Cryptography: Theory And Practice” by Douglas R. Stinson. The process is simple enough to be performed directly by a human, without an auxiliary computing device. A drawback is that the user needs to carry the substitution table with him or her. In addition, this method is not cryptographically secure: By analyzing a sufficient amount of encrypted data, an eavesdropper can use statistical properties of the language to deduce the table and decrypt the messages. This risk can be completely eliminated by using a different substitution table for each letter in the message. In this case, the approach is equivalent to using a one-time pad, a mathematically proven perfectly secure encryption method. For a more detailed description, a reference is made to pages 52-53 of “Cryptography: Theory And Practice”. A serious drawback is that the user needs to carry a number of substitution tables with him or her, one for each letter or character in the message he or she wants to encrypt. A trade-off between security and convenience can be achieved by using a plurality of substitution tables, the number of tables being greater than one but less than the number of letters in the message. The message is split in a plurality of parts, the parts not necessarily being contiguous, and each part encrypted using a different substitution table.

A method of secure user authentication over an insecure channel is disclosed in U.S. Pat. No. 7,149,899. Basically, it is a challenge-response method, where the user and the authenticating application share the knowledge of a secret character string (a personal identification number or PIN). The application creates a random, different string and presents it as the challenge to the user wishing to authenticate him/herself. The user demonstrates the knowledge of the PIN by entering the difference between the PIN and the challenge as the response. To prevent an automated adversary from eavesdropping on the challenge and response and deducing the PIN, the challenge is transmitted in a perceptually modified, distorted form which makes it substantially difficult to be used by an automated adversary unaided by a human being, but which is still easily understandable by a human being. Instead of the difference, any other function of the PIN and the challenge can be used, provided the user can easily compute it. Also, the secret string is not limited to a numerical PIN, but can be any textual password. In this case, to facilitate the computation of the difference or offset between the challenge and the password, the user can be provided a look-up table giving the offsets between all pairs of letters. The look-up table is not secret and and can be transmitted to the user in any convenient way. Still, this method is limited to secure transmission of messages which are related to a secret string which has been established in advance. It cannot be used for secure transmission of arbitrary messages, unknown to the recipient.

### BRIEF SUMMARY OF THE INVENTION

A method of, and a system for, secure communication between a human user and a computer application over an insecure channel is provided. The communication is secure in the sense that it is encrypted and that it is substantially difficult for an automated adversary, unaided by a human being, to deduce the plaintext from data transmitted over the insecure channel. The method is directly suitable for textual data. Combined with a suitable encoding, for example BASE64, the method can be used for secure transmission of any type of digital data.

The user encrypts the textual input using at least one character substitution table. Preferably, a different table is used for encrypting each input character. The character substitution tables are provided to the user over an insecure channel, but in a perceptually modified, distorted form which makes them substantially difficult for use by an automated agent unaided by a human being. For a detailed description of such perceptual modifications, reference is made to U.S. Pat. No. 6,195,698, FIGS. 3 and 4 and their descriptions.

### BRIEF DESCRIPTION OF THE SEVERAL VIEWS OF THE DRAWING

FIG. 1 is a block diagram of an exemplary system which uses the invention.

FIG. 2 is a block diagram of the secure subsystem and its cooperation with the rest of the system.

FIG. 3 is a flow diagram showing secure reception of user input.

FIG. 4 is a flow diagram showing in more detail how character substitution tables are presented to the user and how user's input is received.

FIG. 5 is a flow diagram showing secure transmission of application output.

FIG. 6 shows an exemplary perceptually distorted character substitution table.

### DETAILED DESCRIPTION OF THE INVENTION

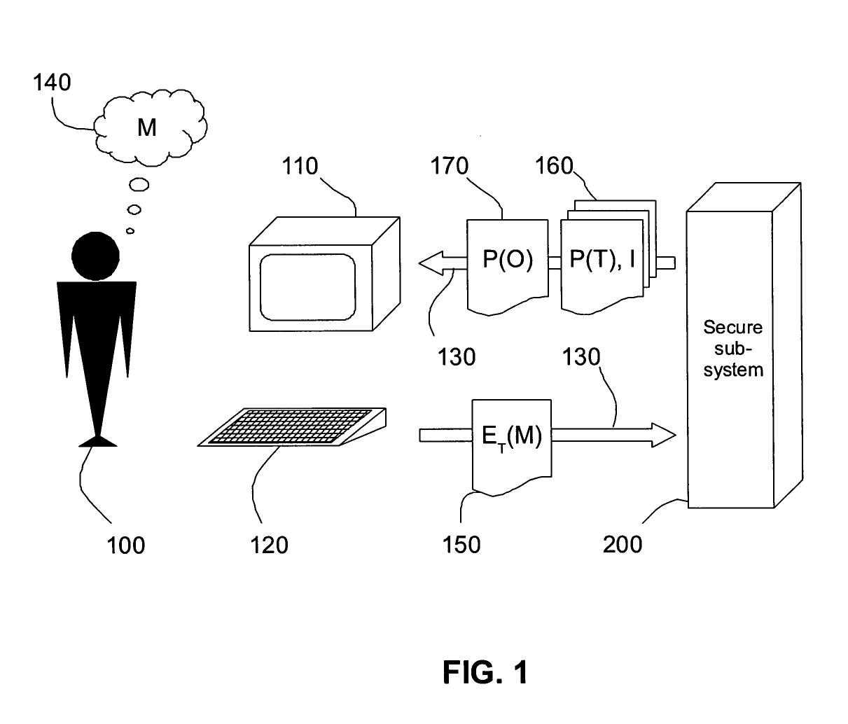

FIG. 1 shows a user (a human being) 100 wishing to send a message M 140 over the secure communication system disclosed here. The secure communication system comprises a secure subsystem 200, described in more detail below, an insecure communication channel 130, an output device 110 and an input device 120. For easier comprehension of the invention, the output device 110 shown in FIG. 1 resembles a computer display. This should be understood only as an example and not in a limiting sense. In different embodiments, the output device may take various forms, for example a loudspeaker or a tactile output device. In the same sense, the input device 120, which is in FIG. 1 by the way of example shown to resemble a keyboard, may in different embodiments take various forms, including, but not limited to, a digitizer, a microphone, a pointing device, and similar.

The insecure communication channel 130 is shown in FIG. 1 to have two directions. The downlink, leading from the secure subsystem 200 towards the output device 110, is used for transmitting a non-empty set of perceptually distorted character substitution tables P(T) and the indication I 160. Indication I indicates which substitution table to use for encrypting which part of the message M 140. In addition, the downlink may be used for transmitting perceptually distorted output P(O) 170 from an application inside the secure subsystem 200. The uplink, leading from the input device 120 towards the secure subsystem 200 is used for transmitting the encrypted user input E_{T}(M) 150. It is to be understood that the two directions shown describe only the logical flow of data and do not imply any particular physical implementation. In different embodiments, the two directions can be implemented on a single physical channel, like a computer bus or a telephone line, on two separate physical channels, for example a satellite dowlink and a telephone line for the uplink, or on a plurality of physical channels where a separate routing mechanism decides on their usage, like on the Internet.

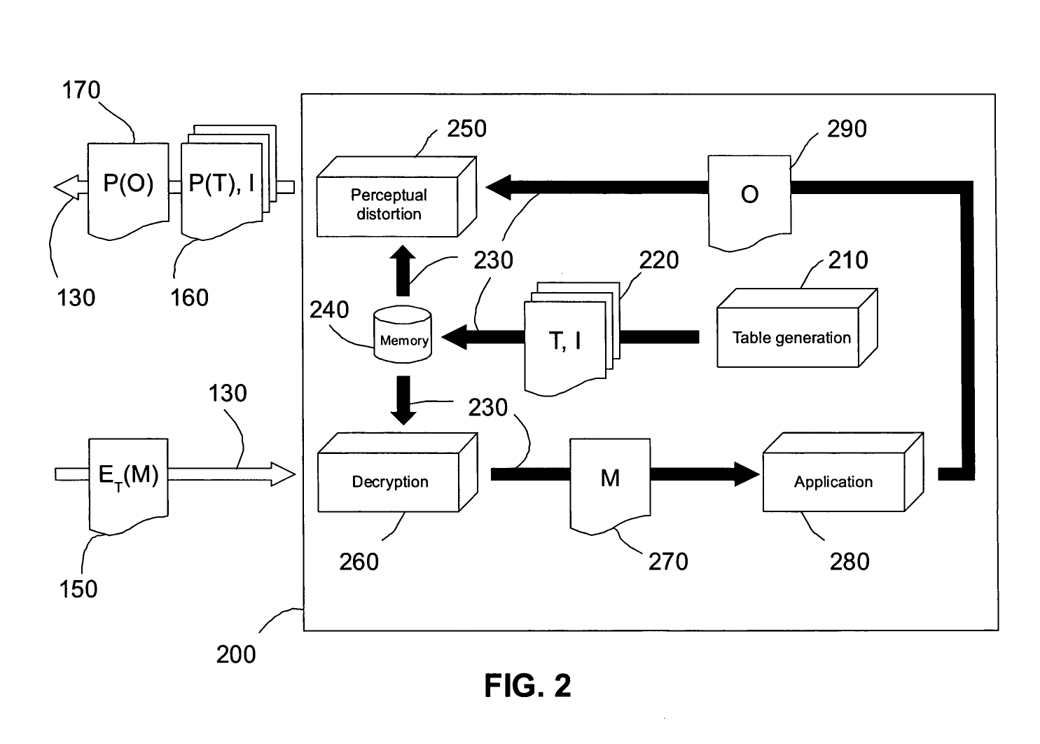

FIG. 2 shows the structure of the secure subsystem 200 and its interfaces to the rest of the system. The subsystem 200 comprises the following logical modules: a module 210 for generating character substitution tables T and the indication I 220; a memory 240 for storing the tables and the indication 220; a module 250 for perceptually distorting the appearance of the tables 220 and, optionally, of the application output 290; a decryption module 260; and the the actual application 280, which is the intended recipient of the decrypted message 270. The communication between the modules is done over channels 230 which are secure against eavesdropping or interception. It is to be understood that the division of the secure subsystem into modules is on a functional level only and does not imply any particular physical implementation. For example, each of the modules 210, 250, 260, and 280 may, independently of other modules, be implemented as one or more separate physical devices, or a single physical device may contain one or more of said modules. Also, each said module may, independently from others, be implemented as a hardware device or as a piece of software running in a programmable device. Such a programmable device can be a personal computer, a server computer, a personal digital assistant, a programmable mobile phone, or similar. One software module may run on one or more programmable devices. Conversely, one programmable device may run one or more of said software modules.

T should be understood to denote a non-empty set of character substitution tables, T={T₁, T₂, . . . , T_{N}}, N being the total number of tables in the set. An arbitrary table from T is denoted by Tᵢ. Similarly, P(T) denotes a set P(T)={p(T₁), p(T₂), . . . , p(T_{N})}, p being a perceptual distortion function. In the text, the plural form “tables” is used to refer to T and P(T), because it is, for security reasons, preferable to use a plurality of tables for encryption. It should be understood, however, that T and P(T) may each hold as few as only one table, in which case the term “tables” should be understood in its singular form “table”. When T contains more than one table, the indication I is used to indicate to the user which table Tᵢ to use for encrypting which part of the message M. If T contains only a single table, I is to be understood as being implied by this single table.

Every character substitution table Tᵢ contains a mapping from every character in the alphabet in which the message M 140 is composed to a different character in the alphabet available on the input device 120. The two alphabets may be, but need not be the same. The term “alphabet” should be understood as a set of characters or symbols, for example ASCII or a subset of the Unicode character set. The tables are stored in the memory 240 for use by the perceptual distortion module 250 and the decryption module 260.

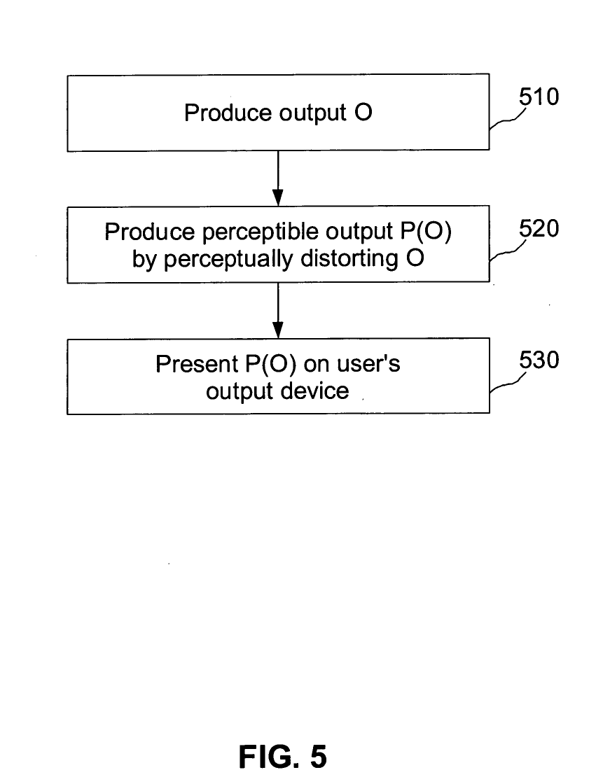

The perceptual distortion module 250 takes each table Tᵢ from the memory 240 and transforms it into a perceptible table p(Tᵢ) in a way which makes it suitable for human perception and at the same time substantially difficult for an automated adversary, for example a malicious computer program unaided by a human being, to discover the character substitution rules. By the way of example, the transformation may include producing an image of the table wherein the characters are shown in different fonts, styles, colors, and sizes. The characters may be moved, rotated, skewed, stretched, or otherwise distorted in their appearance. Noise, background patterns, shadows, or lightning effects may be added to each character or to the image as a whole. Also by the way of example, the transformation may include making an audible representation of the table wherein the characters are reproduced in different voices, tones, pitches, tempo or otherwise distorted. Also, acoustic noise or other distracting sounds may be added to each character or to the whole audio representation. Again, for a detailed description of such perceptual modifications, reference is made to U.S. Pat. No. 6,195,698. An example of a visually distorted character substitution table is shown in FIG. 5, which is described in more detail below. In addition, the perceptual distortion module 250 may be applied for transforming an output O 290 from the application 280 into a perceptible output P(O) 170, which is substantially difficult to use for an automated adversary.

The perceptible tables P(T) and the indication I 160 are made available to user's output device 110 over the insecure channel 130 outside the secure subsystem 200. The output device 110 is also used for presenting the perceptible output P(O) 170, which is also made available to it over the insecure channel 130.

The decryption module 260 takes the encrypted message 150 and the character substitution tables T together with the indication I 220 and produces the decrypted message 270 by reversing the substitution. The encrypted message 150 is made available to the decryption module 260 over the insecure channel 130 outside the secure subsystem 200. The character substitution tables T and the indication I 220 are retrieved from the memory 240. The tables are the same ones which were, in their distorted form P(T) 160, made available to the user's output device 110. The decrypted message 270 is transmitted over the secure channel 230 to the application module 280, which is the intended recipient of the message.

Independently from receiving input, the application 280 may produce an output O 290 and pass it to the perceptual distortion module 250.

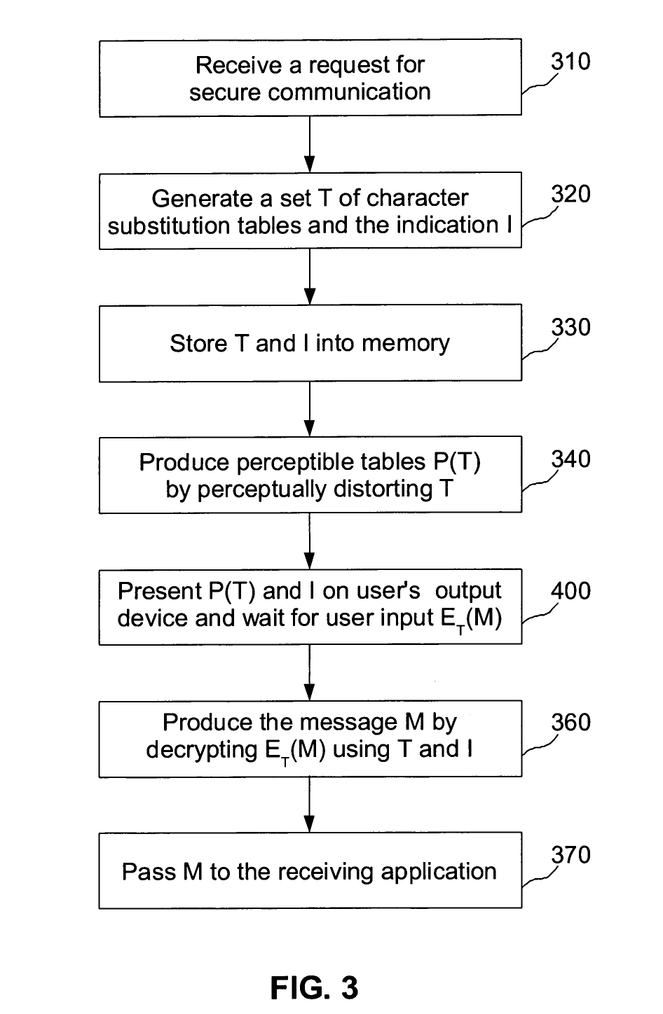

FIG. 3 shows a flow diagram of the secure communication process from the user to the application. In a preferred embodiment, user 100, wishing to send a message M 140 over the insecure channel 130 to the application 280, establishes a connection to the secure subsystem 200 and requests secure communication. By the way of example, if the secure subsystem 200 is hosted on a remote site on the Internet, the connection may be established by navigating the site using a Web browser. The request for secure communication may be implied by establishing the connection, or may be expressed by performing an action on a corresponding input element on the Internet site, like clicking a displayed button with the mouse. Also by the way of example, if the secure subsystem 200 is a device attached to user's computer, the connection may be established by starting a program for accessing the device. As in the previous example, the request for communication may be implied by establishing the connection, or may be expressed by performing an action on an input element of the program for accessing the secure subsystem. These examples should not be understood in a limiting sense. Those skilled in the art will readily recognize that there are numerous ways of establishing a connection and requesting secure communication with a secure subsystem.

Having received the request for secure communication (step 310), the secure subsystem in step 320 generates character substitution tables T and the indication I. It is desirable to generate the tables in an unpredictable way, for example by a random or a pseudo-random process. In step 330 these tables and the indication are stored into memory. Perceptual distortion of the tables is performed in step 340. Step 400 comprises sending the perceptually distorted tables P(T) and the indication I to the user's output device and receiving the encrypted message E_{T}(M) from the user's input device. User produces E_{T}(M) by substituting each character in the original message M, with the corresponding character as specified in the tables T.

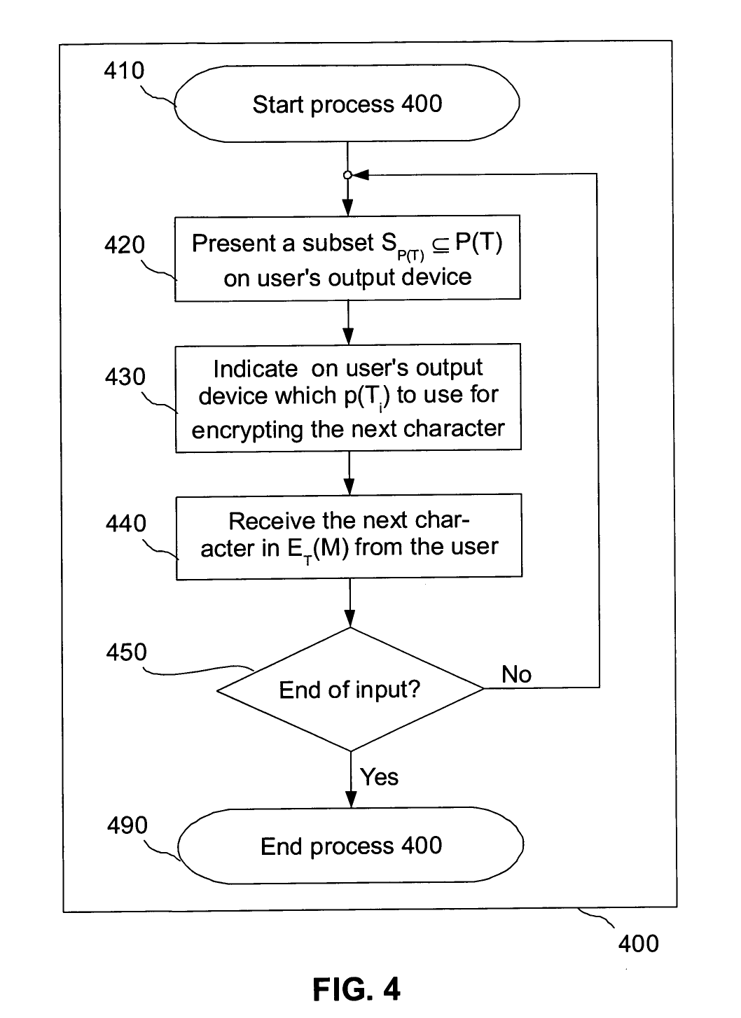

In a simple embodiment, where security requirements are low, a set T containing only one character substitution table may be used for encrypting the whole message M. In this case, step 400 is straightforward and comprises sending this only table T and receiving the whole encrypted message E_{T}(M). The indication I is implied by the single table T. If, for increased security, T contains a plurality of tables, step 400 is itself a process comprising several steps, shown in FIG. 4 and described below.

In step 360 the plaintext message M is produced from encrypted message E_{T}(M) by reversing the substitution specified in tables T and the indication I. In step 370 this plaintext message is passed to the application, which is, from user's point of view, the intended recipient.

FIG. 4 shows in more detail step 400 in a preferred case, where a plurality of character substitution tables T is used for encryption. It is implied that initially, at the start of the process in step 410, the encrypted message E_{T}(M) is empty. In step 420 a non-empty subset S_{P(T)} of perceptually distorted character substitution tables P(T) is presented on user's output device. The subset may be improper, that is, it may include all tables from P(T). Exactly one table from S_{P(T)}, here called the “current table” and denoted by T_{C}, is to be used for encrypting the next character from M.

In step 430, along with S_{P(T)}, an indication I is presented on user's output device. I indicates to the user which of the tables from S_{P(T)} is the current table T_{C}. The choice of subset S_{P(T)} and indication I may take various forms. In a preferred embodiment, only one table is presented at a time, that is, S_{P(T)} contains only the current table T_{C}. Presenting this table is at the same time the indication that this table is to be used for encrypting the next character from M. In another preferred embodiment, more than one table is presented concurrently, that is, S_{P(T)} has more than one element. In this case the indication I might, for example, be presented by perceptually emphasizing T_{C}. The emphasize may include visually rendering T_{C} in a different size, brightness, color, or similar, with a distinguishing border around it, at a specially marked position on the output device, or similar. For acoustic representation, T_{C} might be reproduced in different volume, tone, pitch, or similar. Yet another possibility is to enumerate or label the presented tables and use the number or label of T_{C} as the indication I. The examples listed here serve only for illustration and should not be understood in a limiting sense. Those skilled in the art will readily recognize that there are numerous ways of indicating one element from a set of presented elements.

The user takes the next character from the message M, encrypts it by substituting it for the character specified in the current table T_{C}, and enters it through the input device. If the whole message M has already been entered, that is, there are no more characters in M to encrypt, the user enters a special character, agreed with the secure subsystem in advance, to signal the end of input. Examples of such special characters may include ASCII codes for carriage return (CR), line feed (LF), end of file (EOF), or similar. Also, instead of a special character, some other user action distinguishable from entering cyphertext may be used. Examples of such action may include clicking the mouse on a predefined area, entering a sequence of characters with predefined speed and delays, or similar.

In step 440 the next character is received from user's input device. In step 450 it is checked whether the end of input has been signaled. If no, the input character is appended to E_{T}(M) and the process repeats from step 420. Otherwise, if the user signaled the end of input, E_{T}(M) is considered complete and process 400 ends.

In a preferred embodiment, the application may produce an output O and present it securely to the user. FIG. 5 shows the secure communication process from the application to the user. In step 510 the application produces an output O. The output is passed to the perceptual distortion module which, in step 520, perceptually distorts it in order to make it hard for an automated adversary to extract useful information from it. In step 530 the perceptually distorted output P(O) is presented on user's output device.

The secure communication method disclosed here may be used for secure user authentication over an insecure channel. The user and the application have to agree in advance on a secret character sequence (a password). This is typically done when the user signs up for a computer-based application or service. Having established the password, the user can at any time authenticate himself or herself towards the application by requesting secure communication and transmitting the password encrypted as specified by the character substitution tables generated by the secure subsystem.

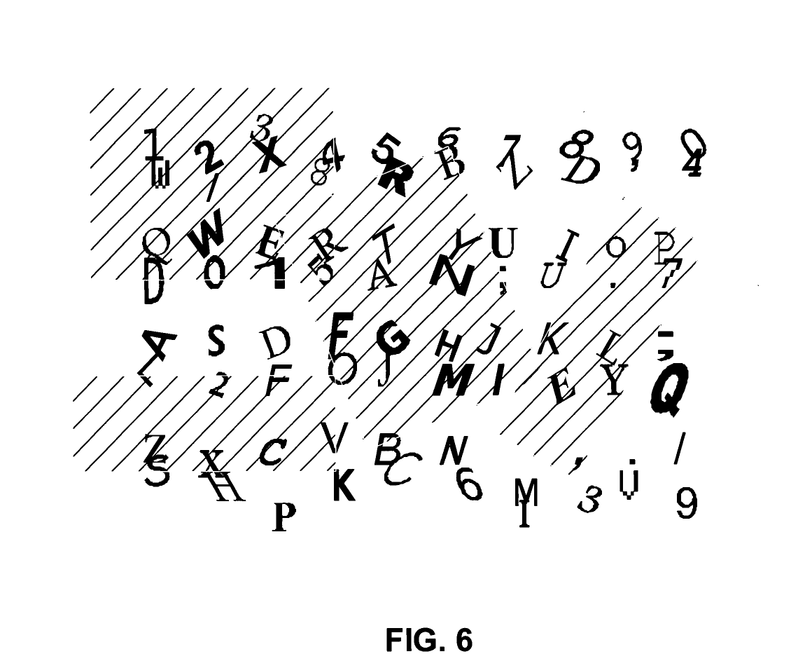

FIG. 6 shows an example of a distorted visual representation of a character substitution table. The table has a background pattern and contains four pairs of rows, each row consisting of distorted images of letters, digits, and punctuation characters. In each of the four pairs of rows, the upper row contains characters arranged like on a common typewriter or computer keyboard. The lower row contains random characters. Together, the upper and the lower row define a mapping from plaintext to cyphertext. So, for example, the first pair of rows contains characters 1, 2, 3 and so on in the upper row and W, I, X and so on in the lower. The intended meaning is that the characters 1, 2, and 3 in the plaintext message M should be substituted with the characters W, I, and X, respectively, when producing the cyphertext E_{T}(M). If, for example, the depicted table is used for encrypting the whole message “HELLO.”, the encrypted message would be “M1YY.V”.

I claim:

1. A secure communication method between a user and a computer application comprising:
generating a non-empty set of character substitution tables;
modifying the appearance of said character substitution tables in a way which renders them substantially difficult to be used by an automated process unaided by a human being but easily understandable by a human being;
presenting said modified character substitution tables to the user;
receiving a sequence of characters from the user, wherein the user encodes each character using said character substitution tables;
decoding the user input using the said character substitution tables.

2. The method of claim 1 wherein said character substitution tables are generated by a random or pseudo-random process.

3. The method of claim 1 comprising, in addition, the following steps:
generating an output by the computer application;
modifying the appearance of said output in a way which renders it substantially difficult to be used by an automated process unaided by a human being but easily understandable by a human being;
presenting said modified output to the user;

4. The method of claim 1 wherein for encoding each character in the input sequence one of said character substitution tables is indicated to the user.

5. The method of claim 4 wherein the indication is performed by presenting the user only one of said character substitution tables at a time

6. The method of claim 4 wherein the indication is performed by perceptually emphasizing one of said character substitution tables.

7. A method for authenticating a user with a computer application over an insecure communication channel comprising the following steps:
establishing a secret character string known both to the user and the application;
receiving the authentication request from the user;
receiving a character string from the user using the method of claim 1;
comparing the received character string with the said established secret character string;
authenticating the user if said received character string and said established secret character string are equal;
not authenticating the user if said received character string and established secret character string are not equal.

8. A system for secure communication between a user and a computer application comprising:
a non-empty set of character substitution tables,
a set of indications to said character substitution tables
an output device permitting presenting information to the user,
an input device permitting the user to input a sequence of characters,
a memory for storing said character substitution tables,
a processing unit capable of performing operations that:
generate said character substitution tables,
generate indications to said character substitution tables
store said character substitution tables and said indications in the memory,
modify the appearance of said character substitution tables,
generate application output,
modify the appearance of said application output,
convey the modified character substitution tables to the output device,
convey the modified application output to the output device,
convey to the user the indication saying which character substitution table to use for encoding user input,
accept user input from the input device,
decode the user input using said character substitution tables and the indications stored in the memory.
